(19) United States
(12) Patent Application Publication
(10) Pub. No.: US 2018/0349927 A1
(43) Pub. Date: Dec. 6, 2018

(54) SERVICE SERVER, OPERATION METHOD THEREOF, AND USER DEVICE

(71) Applicant: SK Planet Co., Ltd., Seongnam-si (KR)

(72) Inventor: Sang Ho JEON, Seongnam-si (KR)

(73) Assignee: SK Planet Co., Ltd.

(21) Appl. No.: 15/996,952

(22) Filed: Jun. 4, 2018

(30) Foreign Application Priority Data
Jun. 5, 2017 (KR) 10-2017-0069765

(51) Int. Cl. G06Q 30/02

(52) U.S. Cl. CPC G06Q 30/0201

(57) ABSTRACT

The present disclosure provides a service server, an operation method thereof, and a user device, in which a re-purchase time point for a product is predicted based on user behavior pattern information identified from a sensing signal detected by an IoT-based sensing device to enable automatic re-purchasing of the product at the predicted time point even without a user's intentional action. Therefore, the present disclosure can improve the exactness of a service, and generally improve the convenience and satisfaction for the service in which a user (consumer) need not make a decision in relation to purchasing of a product by himself or herself.

### CROSS-REFERENCE TO RELATED APPLICATIONS

The present application claims priority to Korean Patent Application No. 10-2017-0069765, filed on Jun. 5, 2017, the entire contents of which are incorporated herein by reference.

### TECHNICAL FIELD

The present disclosure relates to a service providing method in which a time point for re-purchase of a specific product is predicted based on a sensing signal detected by an Internet-Of-Things (IoT)-based sensing device, so as to enable automatic purchase of the product.

### BACKGROUND

The statements in this section merely provide background information related to the present disclosure and may not constitute prior art.

Information Technology (IT) applied to an e-commerce business is focusing on a time point after need for a produce needs occurs.

Meanwhile, current e-commerce business operators provide a commerce service such as regular delivery for frequently purchased products for previously providing a product at a time point before occurrence of demand for the product.

However, in the conventional commerce service as described above, an unnecessary regular delivery of a product to a consumer may occur even when the consumer does not want to order the product.

In this case, the customer should return the regularly delivered product, which is an unsatisfactory experience for the customer.

Therefore, in order to solve the problems of the conventional commercial service, the present disclosure proposes a new service method in which a re-purchase time point for a product is predicted to enable automatic purchasing of the product at the predicted time point.

### SUMMARY

The present disclosure has been made in view of the above circumstances, and an aspect of the present disclosure is to provide a service providing method, which can predict a re-purchasing time point for a product on the basis of user behavior pattern information identified from a sensing signal detected by an IoT-based sensing device and thus can process automatic purchasing of the product at the predicted time point even without a user's intentional action.

In view of the above aspects, a service server according to an embodiment of the present disclosure includes: a processor configured to perform a process to provide a service; and a memory configured to store at least one command executed by the processor, wherein the at least one command includes: a generation command configured to generate user behavior pattern information based on sensing information detected for a predetermined time interval by a sensing device; a determination command configured to determine whether purchase time point behavior pattern information defined for each product includes purchase time point behavior pattern information which coincides with the user behavior pattern information by a degree larger than or equal to a threshold value; and a transfer command configured to, when purchase time point behavior pattern information of a particular product coincides with the user behavior pattern information by a degree larger than or equal to a threshold value, transfer notification information indicating that automatic purchasing of the particular product is to be progressed.

More specifically, the purchase time point behavior pattern information of the particular product may be defined by user behavior pattern information based on sensing information detected by the sensing device during an analysis period from a purchase time point of the particular product to a re-purchase time point of the particular product.

More specifically, when two or more analysis periods exist, the purchase time point behavior pattern information of the particular product may be defined based on an average value of user behavior pattern information generated in the two or more analysis periods.

More specifically, a correction value is applied to the average value of the user behavior pattern information for enabling the purchase time point behavior pattern information of the particular product to be closer to user behavior pattern information corresponding to an analysis period closer to a current time point among the two or more analysis periods.

More specifically, the correction value is determined by an average variance in user behavior pattern information corresponding to analysis periods among the two or more analysis periods.

More specifically, the at least one command further includes an acquisition command configured to acquire sensing information from a user device which receives the sensing information from the sensing device when entering a communication coverage of the sensing device.

More specifically, the transfer command is configured to transfer the notification information to the user device when it is identified that the user device enters the communication coverage of the sensing device.

In view of the above aspects, a user device according to an embodiment of the present disclosure includes: a processor configured to perform a process associated with a service; and a memory configured to store at least one command executed by the processor, wherein the at least one command includes: a reception command configured to receive sensing information detected for a predetermined time interval by a sensing device; a transfer command configured to transfer the sensing information received from the sensing device to a service server to enable the service server to generate user behavior pattern information based on the sensing information; and a display command configured to display notification information indicating that automatic purchasing of the particular product is to be progressed, when it is determined that purchase time point behavior pattern information defined for each product matching the sensing device includes purchase time point behavior pattern information of a particular product coinciding with the user behavior pattern information by a degree larger than or equal to a threshold value.

More specifically, the sensing information and the notification information are received from the sensing device and the service server, respectively, when the user device enters the communication coverage of the sensing device.

In view of the above aspects, an operation method of a service server according to an embodiment of the present disclosure includes: generating user behavior pattern information based on an accumulation state of sensing information detected for a predetermined time interval by a sensing device; determining whether purchase time point behavior pattern information defined for each product matching the sensing device includes purchase time point behavior pattern information which coincides with the user behavior pattern information by a degree larger than or equal to a threshold value; and when it is determined that purchase time point behavior pattern information of a particular product, which coincides with the user behavior pattern information by a degree larger than or equal to a threshold value, exists, transferring notification information indicating that automatic purchasing of the particular product is to be progressed, to a user.

More specifically, the purchase time point behavior pattern information of the particular product may be defined by user behavior pattern information based on an sensing information detected by the sensing device during an analysis period from a purchase time point of the particular product to a re-purchase time point of the particular product.

More specifically, when two or more analysis periods exist, the purchase time point behavior pattern information of the particular product may be defined based on an average value of user behavior pattern information generated in the two or more analysis periods.

More specifically, a correction value is applied to the average value of the user behavior pattern information for enabling the purchase time point behavior pattern information of the particular product to be closer to user behavior pattern information, which corresponds to an analysis period closer to a current time point among the two or more analysis periods.

More specifically, the correction value is determined by an average variance in user behavior pattern information corresponding to adjacent analysis periods among the two or more analysis periods.

In a service server, an operation method thereof, and a user device according to an aspect of the present disclosure, a re-purchase time point for a product is predicted based on user behavior pattern information identified from a sensing signal detected by an IoT-based sensing device to enable automatic re-purchasing of the product at the predicted time point even without a user's intentional action. Therefore, the present disclosure can improve the exactness of a service, and generally improve the convenience and satisfaction for the service in which a user (consumer) need not make a decision in relation to purchasing of a product by himself or herself.

Further areas of applicability will become apparent from the description provided herein. It should be understood that the description and specific examples are intended for purposes of illustration only and are not intended to limit the scope of the present disclosure.

### DRAWINGS

The above and other aspects, features and advantages of the present disclosure will be more apparent from the following detailed description taken in conjunction with the accompanying drawings, in which:

FIG. 1 is a schematic diagram illustrating a service system according to an embodiment of the present disclosure;

FIG. 2 is a view for describing a sensing device according to an embodiment of the present disclosure;

FIG. 3 is a schematic block diagram of a user device according to an embodiment of the present disclosure;

FIG. 4 is a view for describing notification information according to an embodiment of the present disclosure;

FIG. 5 illustrates an example of a hardware system for implementing a user device according to an embodiment of the present disclosure;

FIG. 6 is a schematic block diagram of a service server according to an embodiment of the present disclosure;

FIG. 7 is a graph for describing a purchase time point behavior pattern according to an embodiment of the present disclosure;

FIG. 8 illustrates an example of a hardware system for implementing a service server according to an embodiment of the present disclosure;

FIG. 9 is a signal flow diagram for describing an operation flow in a service system according to an embodiment of the present disclosure;

FIG. 10 is a schematic flowchart for describing an operation flow in a user device according to an embodiment of the present disclosure; and

FIG. 11 is a schematic flowchart for describing an operation flow in a service server according to an embodiment of the present disclosure.

The drawings described herein are for illustration purposes only and are not intended to limit the scope of the present disclosure in any way.

### DETAILED DESCRIPTION

It should be noted that the technical terms in the present specification are merely used for describing a specific embodiment and are not intended to limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

Hereinafter, exemplary embodiments of the present disclosure will be described in detail with reference to the accompanying drawings, equal or similar elements are assigned an equal reference numeral, and an overlapping description thereof will be omitted. Further, in the following description of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the spirit of the present disclosure should not be construed as being limited by the accompanying drawings. In addition to the accompanying drawings, the spirit of the present disclosure should be construed to cover all modifications, equivalents, and alternatives thereof.

Hereinafter, an embodiment of the present disclosure will be described with reference to the accompanying drawings.

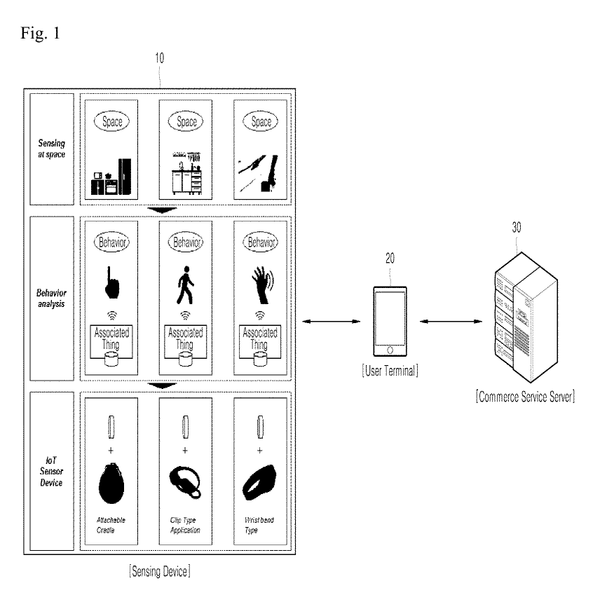

FIG. 1 is a diagram illustrating a service system according to an embodiment of the present disclosure.

As illustrated in FIG. 1, a service system according to an embodiment of the present disclosure may include a sensing device 10, a user device 20, and a service device 30.

The sensing device 10 refers to an IoT-based sensor device for securing information relating to a user's behavior through various IC sensors based on physical hardware, and is configured to store, in an internal storage space (for example, a NAND flash memory) sensing information obtained through sensing during a predetermined time interval, and transmit the stored sensing information to the user device 20 through a near field communication (for example, Bluetooth) when an access of the user device 20 is identified.

For reference, the sensing device 10 according to an embodiment of the present disclosure basically pursues a low power consumption, a compact size, and a light specification through a specific sensing function of a single sensor, rather than multiple functions, in order to prevent a hardware stack increase and an expense increase at the time of the multiple functions from causing an entry bather against service experience.

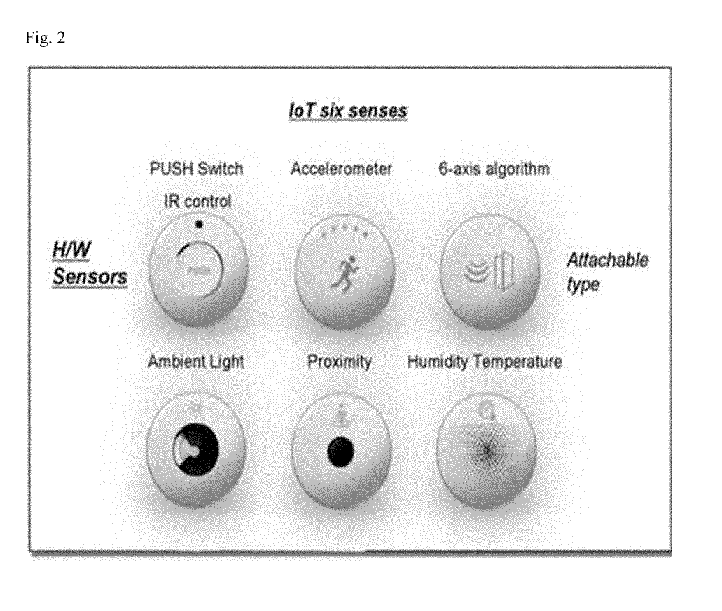

As shown in FIG. 2, the sensing device 10 may correspond to a push (haptic) sensor configured to manage usability, an acceleration sensor configured to sense a movement route in a daily life, a 6-axis acceleration sensor configured to sense a behavior of opening or closing a drawer, etc., an illumination sensor configured to sense a behavior of turning on or off a light in an indoor bathroom, etc., a proximity sensor configured to sense a frequency of using behaviors on the basis of only proximity, or a temperature/humidity sensor configured to sense a frequency of using behaviors and consumption according to weather change. Moreover, the sensing device is not limited to those enumerated above and may include all devices capable of continuously sensing a consumer's daily life pattern through a simple hardware sensing function.

For example, a case where the sensing device 10 according to an embodiment of the present disclosure is implemented in a form including a push (haptic)-based core module and an attachable application accessory kit coupled to each other and is then attached to a power driving unit of a washing machine may be taken into account. In this case, the sensing device 10 may accumulatively stores, as sensing information, the number of times by which a user has pressed the power driving unit for use of the washing machine and, when access of a user device 20 is identified, may transmit the stored sensing information to the user device 20.

The user device 20 refers to a device carried by a user, and functions as a gateway which receives sensing information from the sensing device 10 through an application installed therein and transfers the information to the service server 30.

The user device 20 as described above may be, for example, a smart phone, a portable device, a mobile device, a personal digital assistant (PDA), a portable multimedia player (PMP) device, a telematics device, a navigation device, a personal computer, a notebook computer, a slate Personal Computer (PC), a tablet PC, an Ultrabook, a wearable device (such as a watch type device (smartwatch), a glass type device (smart glass), or Head Mounted Display (HIVID)), a Wibro device, a flexible device. Further, the user device is not limited to those enumerated above and may include all devices in which an application for a service can be installed.

The service server 30 refers to a server device configured to manage a service, and manages a series of processes from a process of predicting a time point for repurchase of a product by analyzing the sensing information detected by the sensing device 10 and a process of automatic purchase of the product.

The service server 30 as described above may be implemented in the form of a web server, a database server, or a proxy server, may include one or more programs installed therein among various software programs enabling a network load distribution mechanism or service device to operate on the Internet or another network, and may be implemented as a computerized system through the programs. Further, the network may be an http network, a dedicated network using private lines, an intra-net, or another type of network. Further, in order to protect data from an attack from a hacker or a third party, components of a system according to an embodiment of the present disclosure may be connected through a security network.

The service server 30 may include a plurality of database servers, and may be implemented by a method in which the database servers are connected with the user device 20 through a predetermined type network connection including a distributed database server architecture.

The above-described configuration of a service system according to an embodiment of the present disclosure can provide an element of convenience for a user (consumer) in view of “an automation which makes it unnecessary for the user to feel the necessity for purchasing and perform the purchasing by himself or herself”.

In other words, a service system according to an embodiment of the present disclosure enables, by applying a physical IoT device in the course of collecting personalized information, collection of information of even a part, collection of information of which is difficult by only software. Further, the system analyzes the collected information to enable automatic product purchase even without user's action up to a time point before pre-transaction (pre-TR), and thus can provide a service environment in which a user (consumer) need not determine by himself or herself in relation to a product purchase behavior.

As described above, a service system according to an embodiment of the present disclosure provides a new type of service, which predicts a time point for re-purchase of a particular product, based on a sensing signal detected by a sensing device 10, so as to enable automatic purchase of the product at the predicted time point. Hereinafter, the user device 20 and the service server 30, which are core elements of the service system, will be described in more detail.

For convenience of description, the following description is based on an assumption that the sensing device 10 is implemented in a form including a push (haptic)-based core module and an attachable application accessory kit coupled to each other and is then attached to a power driving unit of a washing machine, and the sensing information detected by the sensing device 10 is based on the number of times by which the user has pressed the power driving unit for use of the washing machine.

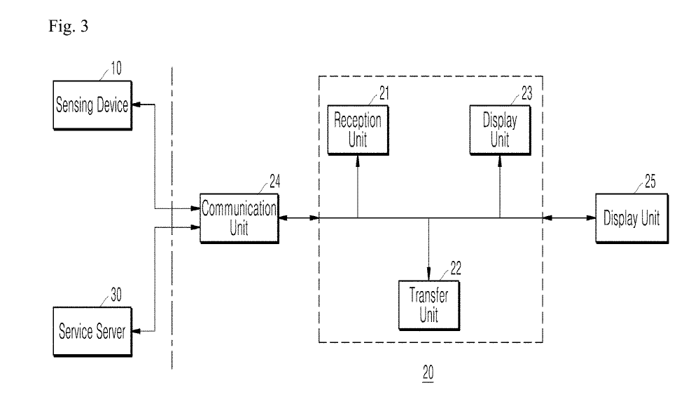

FIG. 3 is a block diagram illustrating a schematic configuration of a user device 20 according to an embodiment of the present disclosure.

As illustrated in FIG. 3, a user device according to an embodiment of the present disclosure may include a reception unit 21 configured to receive sensing information, a transfer unit 22 configured to transfer sensing information, and a display unit 23 configured to display notification information.

The entirety or at least a part of the configuration of the user device 20 including the reception unit 21, the transfer unit 22, and the display unit 23 may be implemented in the form of a hardware module or a software module executed by a processor, or may be in the form in which a software module and a hardware module are combined.

The user device 20 according to an embodiment of the present disclosure may further include a communication unit 24 and a display unit 25, in addition to the elements described above.

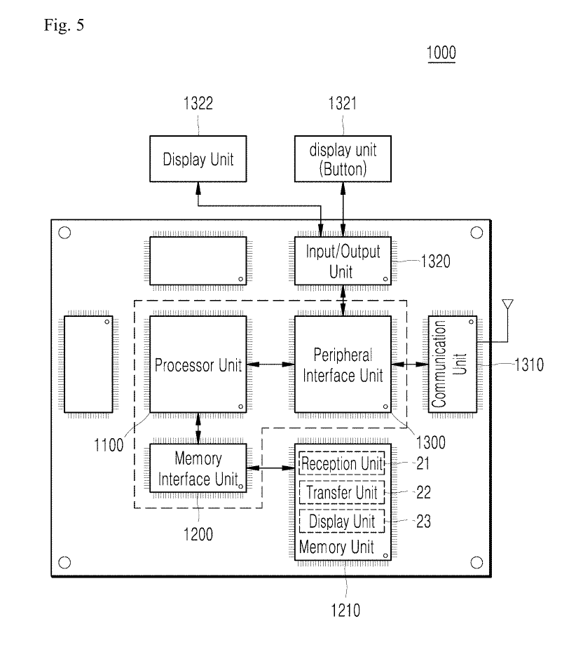

The configurations of the communication unit 24 and the display unit 25 correspond to a communication unit 1310 and a display unit 1321, which will be described later with reference to FIG. 5, so a more detailed description thereof will be given later.

In other words, the user device 20 according to an embodiment of the present disclosure may transfer the sensing information received from the sensing device 10 to the service server 30 through a core configuration including the reception unit 21, the transfer unit 22, and the display unit 23. Hereinafter, each element of the core configuration of the user device 20 will be discussed in more detail.

The reception unit 21 performs a function of receiving sensing information.

Specifically, when the user device 20 enters a communication coverage of the sensing device 10, the reception unit 21 receives sensing information from the sensing device 10 through a near field communication (for example, Bluetooth communication).

In other words, when the user device 20 approaches a washing machine in which the sensing device 10 is located, the reception unit 21 establishes a communication connection (e.g., pairing) with the sensing device 10 and receives, from the sensing device 10, sensing information corresponding to the number of times by which the user has pressed the driving button of the washing machine.

Specifically, the reception unit 21 may receive the sensing information through a pull scheme in which the sensing device 10 is requested to transmit the sensing information, or a push scheme in which the sensing information is received from the sensing device 10 without a separate request.

The sensing information received from the sensing device 10 in the way as described above is accumulated and stored in an internal storage space (e.g., NAND flash) of the user device 20.

The transmission unit 22 performs a function of transmitting sensing information.

More specifically, the transmission unit 22 transmits the sensing information received from the sensing device 10 to the service server 30 to enable the service server 30 to generate user behavior pattern information on the basis of the accumulation state of the sensing information.

In other words, when an arrival of a configured period is identified or a request from the service server 30 is identified, the transmission unit 22 transmits the sensing information, which has been received from the sensing device 10 and accumulatively stored, to the service server 30.

The sensing information transferred to the service server 30 may include location information of the sensing device 10 and identification information of the user device 20.

The location information of the sensing device 10 refers to information used for the sensing device 10 to identify an IoT device attached to a washing machine, and the identification information of the user device 20 refers to information used for identification of a user, such as a user ID, a phone number, or an application ID.

Meanwhile, the user behavior pattern information generated based on the accumulation state of the sensing information in the service server corresponds to the accumulation state of the sensing information, that is, the number of times by which a user has pressed the power driving unit of the washing machine during a predetermined period (e.g., 4 weeks), and this can be understood as the number of times by which the user has used the washing machine during the same period.

The display unit 23 performs a function of displaying notification information.

More specifically, when receiving, from the service server 30, notification information notifying that automatic purchasing of a particular product associated with a location at which the sensing device 10 is installed is to be progressed, the display unit 23 displays the received notification information to enable the user to recognize the progressing state of the service.

When the user device 20 approaches a washing machine in which the sensing device 10 is located, the display unit 23 may receive notification information from the service server 30 by notifying the service server 30 that the user device 20 has approached the washing machine in which the sensing device 10 is located.

It is natural that, in addition to the function of displaying notification information, the display unit 20 can provide, through a separate User Interface (UI), a function allowing a user to approve or deny the automatic purchase processing performed by the service server 30.

In this regard, after generation of user behavior pattern information, when purchase time point behavior pattern information defined for each of products (consumable household products) matching the position (washing machine) wherein the sensing device 10 is located includes purchase time point behavior pattern information of a particular product (e.g., detergent), which coincides with the user behavior pattern information by a degree higher than or equal to a threshold value, the service server 30 may identify the approaching of the exhaustion of the product and transfer, to the user device 20, notification information indicating that automatic purchase processing will be performed.

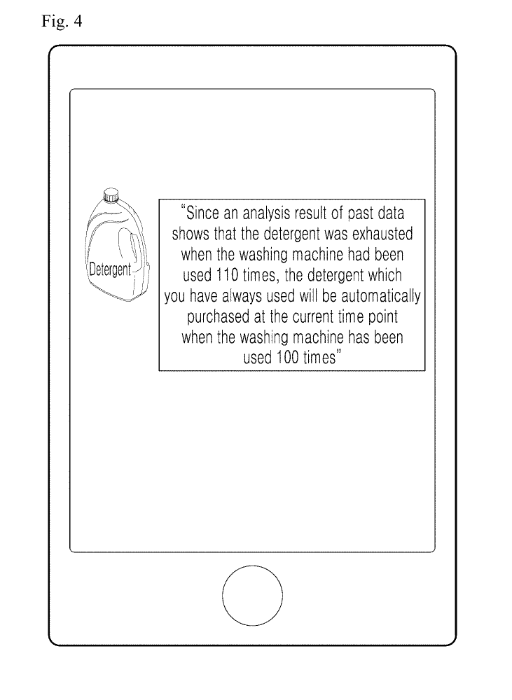

The notification information transferred to the user device 20 may include, for example, a notification message “since an analysis result of past data shows that the detergent was exhausted when the washing machine had been used 110 times, the detergent which you have always used will be automatically purchased at the current time point when the washing machine has been used 100 times”, as shown in FIG. 4.

For reference, the purchase time point behavior pattern information defined for each of products (consumable household products) matching the location position (washing machine) of the sensing device 10 may be defined by user behavior pattern information based on the accumulation state of the sensing information detected by the sensing device 10, a detailed description of which will be given below when the service server 30 is discussed.

As already described above, the elements within the user device 20 may be implemented in the form of a hardware module or a software module executed by a processor, or may be in the form in which a software module and a hardware module are combined.

The form of a hardware module or a software module executed by a processor, or the form in which a software module and a hardware module are combined may be implemented by an actual hardware system (e.g., computer system).

Hereinafter, a hardware system 1000 for implementing a user device 20 according to an embodiment of the present disclosure will be described with reference to FIG. 5.

For reference, it should be noted that, although the elements of the user device 20 in the example described above are implemented in the hardware system 1000, the elements and the operations thereof may be different from those in an actual system.

As illustrated in FIG. 5, a hardware system 1000 according to an embodiment of the present disclosure may include a processor unit 1100, a memory interface unit 1200, and a peripheral interface unit 1300.

Each element of the hardware 1000 as described above either may be an individual element or may be connected to one or more integrated circuits, and the elements may be combined by a bus system (not shown).

The bus system corresponds to an abstraction which indicates multi-drop or point-to-point connections, communication lines/interfaces, and/or one or more predetermined physical buses connected by proper bridges, adaptors, and/or controllers.

In order to enable the hardware system to perform various functions, the processor unit 1100 communicates with the memory unit 1210 through the memory interface unit 1200 to execute various software modules stored in the memory unit 1210.

In the memory unit 1210, the reception unit 21, transfer unit 22, and the display unit 23, which are core elements within the user device 20 described above with reference to FIG. 3, may be stored in the form of a software (application) module, and another Operating System (OS) may be additionally stored.

An operating system (e.g., in the case of an embedded operating system, such as I-OS, Android, Darwin, RTXC, LINUX, UNIX, OS X WINDOWS, or VxWorks) includes various procedures, instruction sets, software components and/or drivers configured to control and manage general system jobs (e.g., memory management, storage device control, power management, etc.), and functions to facilitate communication between various hardware modules and software modules.

For reference, the memory unit 1210 includes a cache, a main memory, and a secondary memory. However, the memory unit may include a memory hierarchical structure not limited thereby, wherein the memory hierarchical structure may be implemented by a predetermined combination of a RAM (e.g., SRAM, DRAM, and DDRAM), a ROM, a FLASH, a magnetic and/or optical storage device (e.g., disc drive, magnetic tape, compact disk (CD), and digital video disc (DVD)).

The peripheral interface unit 1300 functions to enable content between the processor unit 1100 and a peripheral device.

The peripheral device is used to provide a different function to the hardware system 1000, and may include, for example, a communication unit 1310 and an input/output unit 1320 in one embodiment of the present disclosure.

The communication unit 1310 functions to provide a communication function for communication with another device. To this end, the communication unit includes, for example, an antenna system, an RF transceiver, at least one amplifier, a tuner, at least one oscillator, a digital signal processor, a CODEC chip-set, and a memory. However, the communication unit is not limited thereto and may include a known circuit configured to perform those functions.

Communication protocols supported by the communication unit 1310 as described above include, for example, a Wireless LAN (WLAN), a Digital Living Network Alliance (DLNA), a Wireless Broadband (Wibro), a World Interoperability for Microwave Access (Wimax), a Global System for Mobile communication (GSM), a Code Division Multi Access (CDMA), a Code Division Multi Access 2000 (CDMA2000), an Enhanced Voice-Data Optimized or Enhanced Voice-Data Only (EV-DO), a Wideband CDMA (WCDMA), a High Speed Downlink Packet Access (HSDPA), a High Speed Uplink Packet Access (HSUPA), an Institute of Electrical and Electronics Engineers (IEEE) 802.16, a Long Term Evolution (LIE), a Long Term Evolution-Advanced (LTE-A), a Wireless Mobile Broadband Service (WMBS), a Bluetooth, a Radio Frequency Identification (RFID), an Infrared Data Association (IrDA) communication, an Ultra-Wideband (UWB) communication, a ZigBee communication, a Near Field Communication (NFC), an Ultra Sound Communication (USC), a Visible Light Communication (VLC), a Wi-Fi communication, and a Wi-Fi Direct communication. Further, wired communication networks may include all of a wired Local Area Network (LAN), a wired Wide Area Network (WAN), a Power Line Communication (PLC), a USB communication, an Ethernet communication, a serial communication, and an optical/coaxial cable communication, and may include, without being limited thereto, all protocols capable of providing a communication environment for communication with another device.

Further, the input/output unit 1320 functions as a controller for controlling an I/O device interworking with another hardware system, and may perform a function of a controller for the display unit 1321 in an embodiment of the present disclosure.

It goes without saying that the display unit 1321 supports a touch interface for identification of a user's selection (click).

The display unit 1321 as described above may implemented by, for example, a Liquid Crystal Display (LCD), A Thin Film Transistor LCD (TFT-LCD), a Light Emitting Diode (LED), an Organic LED (OLED), an Active Matrix OLED (AMOLED), a retina display, a flexible display, and 3-dimensional display.

Therefore, the elements of the user device 20 stored in the form of software modules in the memory unit 1210 interwork with the communication unit 1310 and the input/output unit 1320 by means of the memory interface unit 1200 and the peripheral device interface unit 1300 in the form of commands executed by the processor unit 1100, so that the user device can transmit the sensing information detected by the sensing device 10 to the service server 30, and display notification information received from the service server 30 to notify the user that a service server is to be progressed.

Hereinafter, for better understanding of the present disclosure, the elements of the user device 20 will be described with reference to FIG. 5, in association with the hardware system 1000.

The reception unit 21 performs a function of receiving sensing information.

More specifically, when it is identified through the communication unit 1310 that the user device 20 has entered the communication coverage of the sensing device 10, the reception unit 21 receives the sensing information from the sensing device 10 through the communication unit 1310 and accumulatively stores the sensing information in an internal storage space (e.g., NAND flash) of the user device 20.

In other words, when the user device 20 approaches a washing machine in which the sensing device 10 is located, the reception unit 21 establishes a communication connection (e.g., pairing) with the sensing device 10 through the communication connection 1310 and then receives, from the sensing device 10, sensing information corresponding to the number of times by which the user has pressed the driving button of the washing machine.

Specifically, the reception unit 21 may receive the sensing information through a pull scheme in which the sensing device 10 is requested to transmit the sensing information, or a push scheme in which the sensing information is received from the sensing device 10 without a separate request.

The transmission unit 22 performs a function of transmitting sensing information.

More specifically, the transmission unit 22 transmits the sensing information received from the sensing device 10 to the service server 30 through the communication unit 1310 to enable the service server 30 to generate user behavior pattern information on the basis of the accumulation state of the sensing information.

In other words, when an arrival of a configured period is identified or a request from the service server 30 is identified, the transmission unit 22 transmits the sensing information, which has been received from the sensing device 10 and accumulatively stored, to the service server 30 through the communication unit 1310.

The display unit 23 performs a function of displaying notification information.

More specifically, when receiving, from the service server 30 through the communication unit 1310, notification information notifying that automatic purchasing of a particular product associated with a location at which the sensing device 30 is installed, the display unit 23 displays the received notification information on the display unit 1321 to enable the user to recognize the progressing state of the service.

When the user device 20 approaches a washing machine in which the sensing device 10 is located, the display unit 23 may receive notification information from the service server 30 by notifying the service server 30, through the communication unit 1310, that the user device 20 has approached the washing machine in which the sensing device 10 is located.

Subsequent to the above description relating to the user device 20 according to an embodiment of the present disclosure, the service server 30 will be described hereinafter.

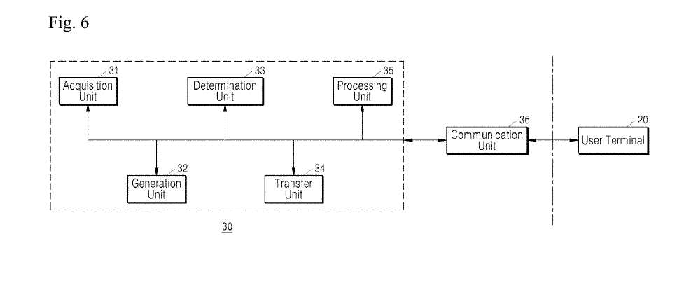

FIG. 6 is a block diagram illustrating a schematic configuration of a service server 30 according to an embodiment of the present disclosure.

As illustrated in FIG. 6, a service server 30 according to an embodiment of the present disclosure may include an acquisition unit 31 configured to acquire sensing information, a generation unit 32 configured to generate user behavior pattern information, a determination unit 33 configured to determine whether user behavior pattern information and purchase time point behavior pattern information coincide with each other, a transfer unit 34 configured to transfer notification information, and a processing unit 35 configured to process automatic product purchasing.

The entirety or at least a part of the configuration of the service server 30 including the acquisition unit 31, the generation unit 32, the determination unit 33, the transfer unit 34, and the processing unit 35 may be implemented in the form of a hardware module or a software module executed by a processor, or may be in the form in which a software module and a hardware module are combined.

The service server 30 according to an embodiment of the present disclosure may further include a communication unit 36 configured to support communication with the user device 20, in addition to the elements described above.

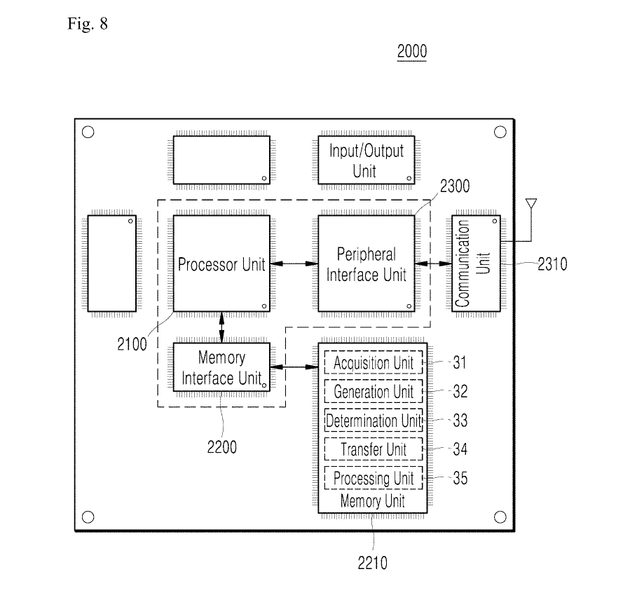

The configuration of the communication unit 36 corresponds to a communication unit 2310, which will be described later with reference to FIG. 8, so a more detailed description thereof will be given later.

The service server 30 can provide a new service server, which predicts a time point for re-purchasing of a product to enable automatic purchasing of the product, through a core configuration including the acquisition unit 31, the generation unit 32, the determination unit 33, the transfer unit 34, and the processing unit 35. Hereinafter, each element of the core configuration of the service server 30 will be discussed in more detail.

The acquisition unit 31 performs a function of acquiring sensing information.

More specifically, the acquisition unit 31 acquires sensing information by receiving the sensing information having been accumulatively stored in the user device 20, from the user device 20 having received the sensing information from the sensing device 10 when entering a communication coverage of the sensing device 10.

The acquisition unit 31 may acquire the sensing information through a pull scheme in which the user device 20 is requested to transmit the sensing information, or a push scheme in which the sensing information is received from the user device 20 without a separate request whenever a configured period arrives.

The sensing information received from the user device 20 as described above is accumulatively stored for a predetermined time interval (e.g., 4 weeks).

The generation unit 32 performs a function of generating user behavior pattern information.

More specifically, the generation unit 32 generates user behavior pattern information on the basis of the accumulation state of the sensing information received from the user device 20.

In other words, based on the accumulation state of the sensing information, that is, the number of times (e.g., 100 times) by which the user has pressed the power operation unit of the washing machine during a predetermined time interval (e.g., 4 weeks), the generation unit 32 may generate user behavior pattern information which implies the number of times (e.g., 100 times) by which the user has used the washing machine during the same time interval.

The determination unit 33 functions to determine whether the user behavior pattern information and the purchase time point behavior pattern information coincide with each other.

More specifically, when the user behavior pattern information is generated based on the accumulation state of the sensing information, the determination unit 33 determines whether purchase time point behavior pattern information defined for each of products (consumable household products) matching the position (washing machine) where the sensing device 10 is installed includes purchase time point behavior pattern information of a particular product (e.g., detergent), which coincides with the user behavior pattern information by a degree higher than or equal to a threshold value.

The purchase time point behavior pattern information defined for each of products (consumable household products, such as detergent or fabric softener) matching the position (washing machine) wherein the sensing device 10 is installed may be defined by user behavior pattern information based on the accumulation state of the sensing information detected by the sensing device 10 during an analysis time period from a purchase time point to a re-purchase time point of each product.

In other words, past user behavior pattern information, i.e., the number of times by which the washing machine has been used, during a separate analysis time period from a purchase time point to a re-purchase time point of each product can be defined as purchase time point behavior pattern information.

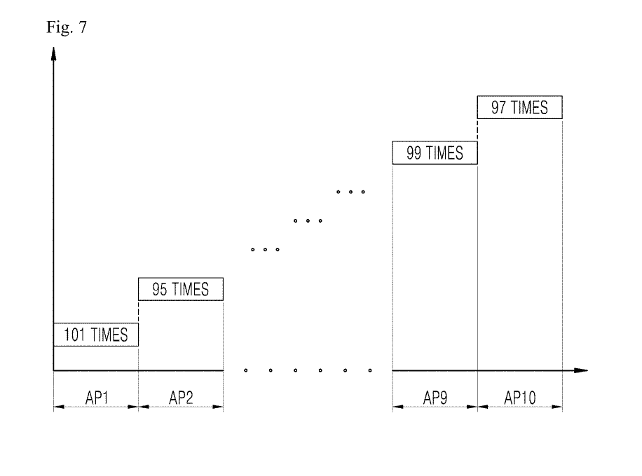

In an embodiment of the present disclosure, as a means for improving the reliability of purchase time point behavior pattern information defined for each product, a plurality analysis periods (AP_1 to AP_10) for defining purchase time point behavior pattern information may be arranged as shown in FIG. 7, and an average value in the number of times, by which the user has used the washing machine for each analysis period, may be defined as the purchase time point behavior pattern information.

However, the user behavior pattern information in each analysis period used to define the purchase time point behavior pattern information may a value changing according to time passage due to, for example, the amount of use of the washing machine changing according to the seasons, and user behavior pattern information corresponding to an analysis period closest to the current time point can be regarded to be closest to user's actual behavior pattern.

Therefore, an embodiment of the present disclosure applies a correction value to enable an average value in the number of times, by which the user has used the washing machine for the analysis periods, to be closer to user behavior pattern information corresponding to an analysis period closest to the current time point.

The correction value is determined by an average variance in the user behavior pattern information between adjacent analysis periods among the plurality of analysis periods (AP_1 to AP_10), that is, as an average value of differences, between adjacent analysis periods, in the number of times by which the washing machine has been used.

Further, in applying the correction value determined in the way as described above, when the average value in the number of times, by which the user has used the washing machine for the analysis periods, is larger than the number of times by which the washing machine has been used in the latest analysis period, the correction value may be subtracted from the average value in the number of times by which the user has used the washing machine for the analysis periods. In the opposite case, the correction value may be added to the average value in the number of times by which the user has used the washing machine for the analysis periods.

For example, in the example described above with reference to FIG. 7, when the average value in the number of times, by which the user has used the washing machine for the analysis periods (AP_1 to AP_10), corresponds to 97 times, the correction value corresponds to 3 times, and the number of times by which the washing machine has been used in the latest analysis period (AP_10) corresponds to 105 times, the correction value, 3, may be added to 97, the average value in the number of times, by which the user has used the washing machine for the analysis periods (AP_1 to AP_10), in order to make the purchase time point behavior pattern information become closer to the number of times by which the washing machine has been used in the latest analysis period (AP_10). As a result, the purchase time point behavior pattern information is defined as 100 times.

As another example, when the average value in the number of times, by which the user has used the washing machine for the analysis periods (AP_1 to AP_10), corresponds to 90 times, the correction value corresponds to 3 times, and the number of times by which the washing machine has been used in the latest analysis period corresponds to 81 times, the correction value, 3, may be subtracted from 90, the average value in the number of times, by which the user has used the washing machine for the analysis periods (AP_1 to AP_10), in order to make the purchase time point behavior pattern information become closer to the number of times by which the washing machine has been used in the latest analysis period. As a result, the purchase time point behavior pattern information is defined as 87 times.

The transfer unit 34 performs a function of transferring notification information.

More specifically, when it is determined that user's purchase time point behavior pattern information defined for each of products (consumable household products) matching the position (washing machine) wherein the sensing device 10 is located includes purchase time point behavior pattern information of a particular product (e.g., detergent), which coincides with the user behavior pattern information by a degree higher than or equal to a threshold value, the transfer unit 34 identifies the approaching of the exhaustion of the product and transfers, to the user device 20, notification information indicating that automatic purchase processing will be performed.

Specifically, when being notified, by the user device 20, of approaching of the washing machine at which the sensing device 10 is installed, the transfer unit 34 transfers, to the user device 20, notification information indicating that automatic purchasing will be progressed. Then, the user device 20 having received the notification information displays the notification information to enable the user to recognize the information and then agree with or deny the automatic purchasing in the service server 30.

The notification information displayed by the user device 20 may include a notification message “since an analysis result of past data shows that the detergent was exhausted when the washing machine had been used 110 times, the detergent which you have always used will be automatically purchased at the current time point when the washing machine has been used 100 times”, as described above with reference to FIG. 4.

The processing unit 35 functions to proceed with automatic purchasing.

More specifically, when an intention to agree with automatic purchasing is received from the user device 20 after transferring the notification information to the user device 20 or a separate intention is not received for a predetermined standby time interval, the processing unit 35 proceeds with automatic processing of a product which is predicted to have approached its exhaust time point, to enable the product to be delivered even without user's intentional action.

When receiving an intention to agree with automatic purchasing from the user device 20, the latest analysis period may be configured as a predetermined time interval in which sensing information has been accumulated to generate the user behavior pattern information, and user behavior pattern corresponding to the configured time interval may be referred to in defining purchase time point behavior pattern information.

As already described above, the elements within the service server 30 may be implemented in the form of a hardware module or a software module executed by a processor, or may be in the form in which a software module and a hardware module are combined.

The form of a hardware module or a software module executed by a processor, or the form in which a software module and a hardware module are combined may be implemented by an actual hardware system (e.g., computer system).

Hereinafter, a hardware system 2000 implementing the elements of the service server 30 according to an embodiment of the present disclosure will be described with reference to FIG. 8.

Among the elements of the hardware system 2000 illustrated in FIG. 8, elements having the same names as those of the hardware system 1000 described above with reference to FIG. 5 may be considered to be the same, so a detailed description of the same elements will not be repeated.

As illustrated in FIG. 8, a hardware system 2000 for implementing the service server 30 according to an embodiment of the present disclosure may include a processor unit 2100, a memory interface unit 2200, and a peripheral interface unit 2300.

In order to enable the hardware system to perform various functions, the processor unit 2100 communicates with the memory unit 2210 through the memory interface unit 2200 to execute various software modules stored in the memory unit 2210.

In the memory unit 2210, the acquisition unit 31, the generation unit 32, the determination unit 33, the transfer unit 34, and the processing unit 35, which are core elements within the service server 30 described above with reference to FIG. 6, may be stored in the form of a software module, and another Operating System may be additionally stored.

The peripheral interface unit 2300 functions to enable communication between the processor unit 2100 and a peripheral device.

The peripheral device is used to provide a different function to the hardware system 2000, and may include, for example, a communication unit 2310 in one embodiment of the present disclosure.

The communication unit 2310 functions to provide a communication function for communication with another device. To this end, the communication unit includes, for example, an antenna system, an RF transceiver, at least one amplifier, a tuner, at least one oscillator, a digital signal processor, a CODEC chip-set, and a memory. However, the communication unit is not limited thereto and may include a known circuit configured to perform those functions.

Therefore, the elements of the service server 30 stored in the form of software modules in the memory unit 2210 communicate with the communication unit 2310 by means of the memory interface unit 2100 and the peripheral device interface unit 2300 in the form of commands executed by the processor unit 2100, and thus can provide a new service, which can predict a time point for repurchasing of a product and enables the product to be automatically purchased at the predicted time point.

Hereinafter, for better understanding of the present disclosure, the elements of the service server 30 will be described with reference to FIG. 8, in association with the hardware system 2000.

The acquisition unit 31 performs a function of acquiring sensing information.

More specifically, through the communication unit 2310, the acquisition unit 31 acquires sensing information by receiving the sensing information having been accumulatively stored in the user device 20, from the user device 20 having received the sensing information from the sensing device 10 when entering a communication coverage of the sensing device 10.

The acquisition unit 31 may acquire the sensing information through a pull scheme in which the user device 20 is requested to transmit the sensing information, or a push scheme in which the sensing information is received from the user device 20 without a separate request whenever a configured period arrives.

The sensing information received from the user device 20 as described above is accumulatively stored for a predetermined time interval (e.g., 4 weeks).

The generation unit 32 performs a function of generating user behavior pattern information.

More specifically, the generation unit 32 generates user behavior pattern information on the basis of the accumulation state of the sensing information received from the user device 20, and transfers the generated user behavior pattern information to the determination unit 33.

In other words, based on the accumulation state of the sensing information, that is, the number of times (e.g., 100 times) by which the user has pressed the power operation unit of the washing machine during a predetermined time interval (e.g., 4 weeks), the generation unit 32 may generate user behavior pattern information which implies the number of times (e.g., 100 times) by which the user has used the washing machine during the same time interval.

The determination unit 33 functions to determine whether the user behavior pattern information and the purchase time point behavior pattern information coincide with each other.

More specifically, when the user behavior pattern information is generated based on the accumulation state of the sensing information, the determination unit 33 determines whether purchase time point behavior pattern information defined for each of products (consumable household products) matching the position (washing machine) where the sensing device 10 is installed includes purchase time point behavior pattern information of a particular product (e.g., detergent), which coincides with the user behavior pattern information by a degree higher than or equal to a threshold value, and transfers a result of the determination to the transfer unit 34.

The transfer unit 34 performs a function of transferring notification information.

More specifically, when it is determined that user's purchase time point behavior pattern information defined for each of products (consumable household products) matching the position (washing machine) wherein the sensing device 10 is located includes purchase time point behavior pattern information of a particular product (e.g., detergent), which coincides with the user behavior pattern information by a degree higher than or equal to a threshold value, the transfer unit 34 identifies the approaching of the exhaustion of the product and transfers, to the user device 20 through the communication unit 2310, notification information indicating that automatic purchase processing will be performed.

Specifically, when being notified, by the user device 20, of approaching of the washing machine at which the sensing device 10 is installed, the transfer unit 34 transfers, to the user device 20, notification information indicating that automatic purchasing will be progressed. Then, the user device 20 having received the notification information displays the notification information to enable the user to recognize the information and then agree with or deny the automatic purchasing in the service server 30.

The notification information displayed by the user device 20 may include a notification message “since an analysis result of past data shows that the detergent was exhausted when the washing machine had been used 110 times, the detergent which you have always used will be automatically purchased at the current time point when the washing machine has been used 100 times”, as described above with reference to FIG. 4.

The processing unit 35 functions to proceed with automatic purchasing.

More specifically, when an intention to agree with automatic purchasing is received through the communication unit 2310 from the user device 20 after transferring the notification information to the user device 20 or a separate intention is not received for a predetermined standby time interval, the processing unit 35 proceeds with automatic processing of a product which is predicted to have approached its exhaust time point, to enable the product to be delivered to the user.

As noted from the above description, elements of a service system according to an embodiment of the present disclosure enable, by applying a physical IoT device in the course of collecting personalized information, collection of information of even a part, collection of information of which is difficult by only software. Further, those elements can analyze the collected information to enable automatic product purchase even without user's action up to a time point before pre-transaction (pre-TR), and thus can provide a service environment in which a user (consumer) need not determine by himself or herself on a product purchase behavior.

Hereinafter, a service system according to an embodiment of the present disclosure and a flow of operations of elements of the service system will be described.

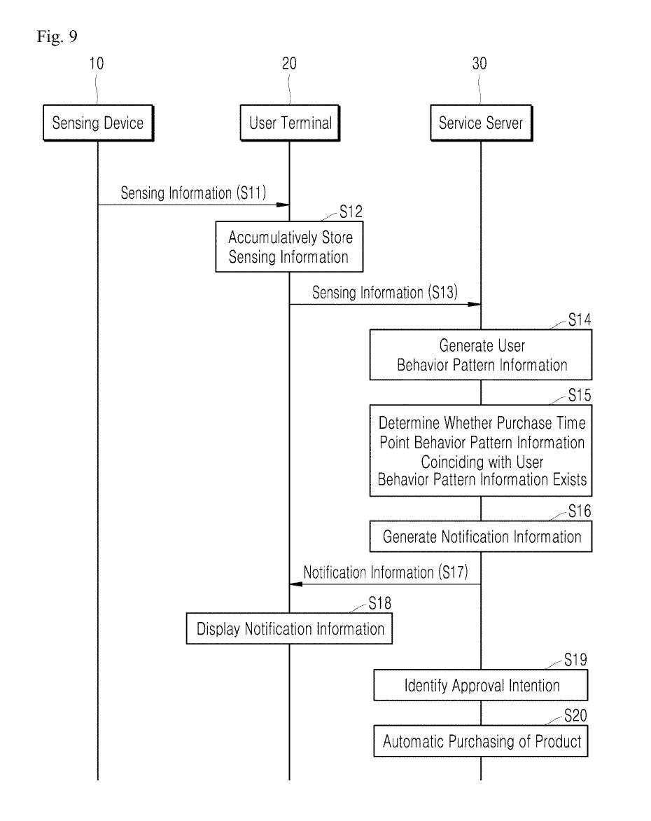

FIG. 9 is a signal flow diagram illustrating an operation flow in a service system according to an embodiment of the present disclosure.

First, when the user device 20 enters a communication coverage of the sensing device 10, the user device 20 receives sensing information from the sensing device 10 through a near field communication (for example, Bluetooth communication) and accumulatively stores the sensing information in an internal storage space (e.g., NAND flash) in operations S11 and S12.

Then, when the user device 20 approaches a washing machine in which the sensing device 10 is located, the user device establishes a communication connection (e.g., pairing) with the sensing device 10 and receives, from the sensing device 10, sensing information corresponding to the number of times by which the user has pressed the driving button of the washing machine.

Thereafter, in step S13, the user device 20 transmits the sensing information received from the sensing device 10 to the service server 30 to enable the service server 30 to generate user behavior pattern information on the basis of the accumulation state of the sensing information.

When an arrival of a configured period is identified or a request from the service server 30 is identified, the user device 20 transmits the sensing information, which has been received from the sensing device 10 and accumulatively stored, to the service server 30.

Then, in step S14, the service server unit 30 generates user behavior pattern information on the basis of the accumulation state of the sensing information received from the user device 20.

Specifically, based on the accumulation state of the sensing information, that is, the number of times (e.g., 100 times) by which the user has pressed the power operation unit of the washing machine during a predetermined time interval (e.g., 4 weeks), the service server 30 may generate user behavior pattern information which implies the number of times (e.g., 100 times) by which the user has used the washing machine during the same time interval.

Then, in step S15, when the user behavior pattern information is generated based on the accumulation state of the sensing information, the service server 30 determines whether purchase time point behavior pattern information defined for each of products (consumable household products) matching the position (washing machine) where the sensing device 10 is installed includes purchase time point behavior pattern information of a particular product (e.g., detergent), which coincides with the user behavior pattern information by a degree higher than or equal to a threshold value.

Thereafter, when it is determined that user's purchase time point behavior pattern information defined for each of products (consumable household products) matching the position (washing machine) wherein the sensing device 10 is located includes purchase time point behavior pattern information of a particular product (e.g., detergent), which coincides with the user behavior pattern information by a degree higher than or equal to a threshold value, the service server 30 identifies the approaching of the exhaustion of the product and transfers, to the user device 20, notification information indicating that automatic purchase processing will be performed, in steps S16 to S18.

When being notified, by the user device 20, of approaching of the washing machine at which the sensing device 10 is installed, the service server 30 transfers, to the user device 20, notification information indicating that automatic purchasing will be progressed. Then, the user device 20 having received the notification information displays the notification information to enable the user to recognize the information and then agree with or deny the automatic purchasing in the service server 30.

Thereafter, in steps S19 and S20, when an intention to agree with automatic purchasing is received from the user device 20 after transferring the notification information to the user device 20 or a separate intention is not received for a predetermined standby time interval, the service server 30 proceeds with automatic processing of a product which is predicted to have approached its exhaust time point, to enable the product to be delivered even without user's intentional action.

Following the above description about a flow of operations of a service system according to an embodiment of the present disclosure, a flow of operations of the user device 20 will be described hereinafter.

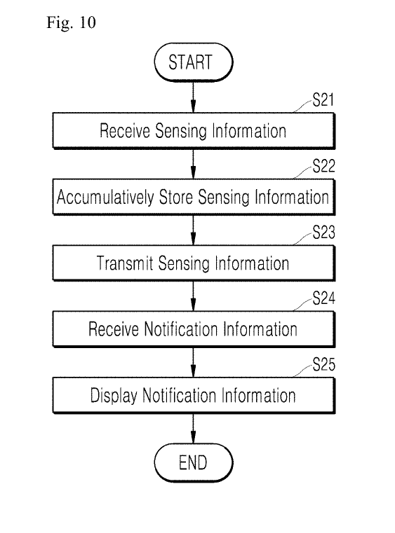

FIG. 10 illustrates an operation flow in a user device 20 according to an embodiment of the present disclosure.

First, in steps S21 and S22, when the user device 20 enters a communication coverage of the sensing device 10, the reception unit 21 receives and accumulatively stores sensing information from the sensing device 10 through a near field communication (for example, Bluetooth communication).

In other words, when the user device 20 approaches a washing machine in which the sensing device 10 is located, the reception unit 21 establishes a communication connection (e.g., pairing) with the sensing device 10 and receives, from the sensing device 10, sensing information corresponding to the number of times by which the user has pressed the driving button of the washing machine.

Specifically, the reception unit 21 may receive the sensing information through a pull scheme in which the sensing device 10 is requested to transmit the sensing information, or a push scheme in which the sensing information is received from the sensing device 10 without a separate request.

The sensing information received from the sensing device 10 in the way as described above is accumulated and stored in an internal storage space (e.g., NAND flash) of the user device 20.

Thereafter, in step S23, the transmission unit 22 transmits the sensing information received from the sensing device 10 to the service server 30 to enable the service server 30 to generate user behavior pattern information on the basis of the accumulation state of the sensing information.

Specifically, when an arrival of a configured period is identified or a request from the service server 30 is identified, the transmission unit 22 transmits the sensing information, which has been received from the sensing device 10 and accumulatively stored, to the service server 30.

The sensing information transferred to the service server 30 may include location information of the sensing device 10 and identification information of the user device 20.

The location information of the sensing device 10 refers to information used for the sensing device 10 to identify an IoT device attached to a washing machine, and the identification information of the user device 20 refers to information used for identification of a user, such as a user ID, a phone number, or an application ID.

Meanwhile, the user behavior pattern information generated based on the accumulation state of the sensing information in the service server corresponds to the accumulation state of the sensing information, that is, the number of times by which a user has pressed the power driving unit of the washing machine during a predetermined period (e.g., 4 weeks), and this can be understood as the number of times by which the user has used the washing machine during the same period.

Further, in steps S24 and S25, when receiving, from the service server 30, notification information notifying that automatic purchasing of a particular product associated with a location at which the sensing device 30 is installed, the display unit 23 displays the received notification information to enable the user to recognize the progressing state of the service.

When the user device 20 approaches a washing machine in which the sensing device 10 is located, the display unit 23 may receive notification information from the service server 30 by notifying the service server 30 that the user device 20 has approached the washing machine in which the sensing device 10 is located.

It is natural that, in addition to the function of displaying notification information, the display unit 20 can provide, through a separate User Interface (UI), a function allowing a user to approve or deny the automatic purchase processing performed by the service server 30.

In this regard, after generation of user behavior pattern information, when purchase time point behavior pattern information defined for each of products (consumable household products) matching the position (washing machine) wherein the sensing device 10 is located includes purchase time point behavior pattern information of a particular product (e.g., detergent), which coincides with the user behavior pattern information by a degree higher than or equal to a threshold value, the service server 30 may identify the approaching of the exhaustion of the product and transfer, to the user device 20, notification information indicating that automatic purchase processing will be performed.

Following the above description about a flow of operations of the user device 20 according to an embodiment of the present disclosure, a flow of operations of the service server 30 will be described hereinafter.

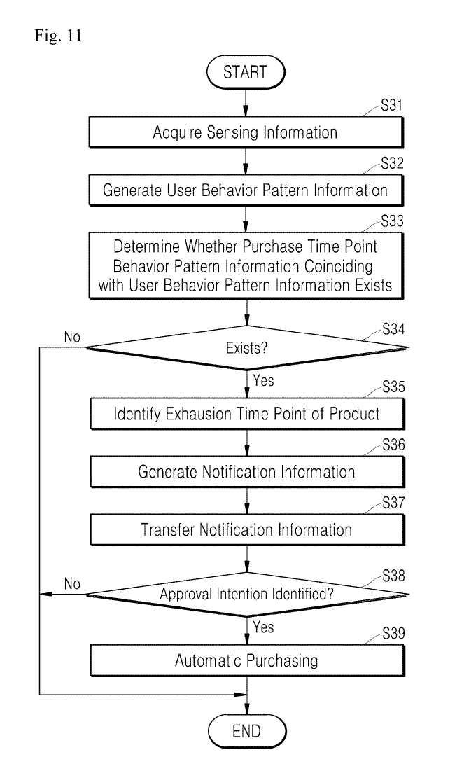

FIG. 11 illustrates a flow of operations of a service server 30 according to an embodiment of the present disclosure.

First, in step S31, the acquisition unit 31 acquires sensing information by receiving the sensing information having been accumulatively stored in the user device 20, from the user device 20 having received the sensing information from the sensing device 10 when entering a communication coverage of the sensing device 10.

The acquisition unit 31 may acquire the sensing information through a pull scheme in which the user device 20 is requested to transmit the sensing information, or a push scheme in which the sensing information is received from the user device 20 without a separate request whenever a configured period arrives.

The sensing information received from the user device 20 as described above is accumulatively stored for a predetermined time interval (e.g., 4 weeks).

Then, in step S32, the generation unit 32 generates user behavior pattern information on the basis of the accumulation state of the sensing information received from the user device 20.

Specifically, based on the accumulation state of the sensing information, that is, the number of times (e.g., 100 times) by which the user has pressed the power operation unit of the washing machine during a predetermined time interval (e.g., 4 weeks), the generation unit 32 may generate user behavior pattern information which implies the number of times (e.g., 100 times) by which the user has used the washing machine during the same time interval.

Then, in step S33, when the user behavior pattern information is generated based on the accumulation state of the sensing information, the determination unit 33 determines whether purchase time point behavior pattern information defined for each of products (consumable household products) matching the position (washing machine) where the sensing device 10 is installed includes purchase time point behavior pattern information of a particular product (e.g., detergent), which coincides with the user behavior pattern information by a degree higher than or equal to a threshold value.

The purchase time point behavior pattern information defined for each of products (consumable household products, such as detergent or fabric softener) matching the position (washing machine) wherein the sensing device 10 is installed may be defined by user behavior pattern information based on the accumulation state of the sensing information detected by the sensing device 10 during an analysis time period from a purchase time point to a re-purchase time point of each product.

In other words, past user behavior pattern information, i.e., the number of times by which the washing machine has been used, during a separate analysis time period from a purchase time point to a re-purchase time point of each product can be defined as purchase time point behavior pattern information.

In an embodiment of the present disclosure, as a means for improving the reliability of purchase time point behavior pattern information defined for each product, a plurality analysis periods (AP_1 to AP_10) for defining purchase time point behavior pattern information may be arranged as shown in FIG. 7, and an average value in the number of times, by which the user has used the washing machine for each analysis period, may be defined as the purchase time point behavior pattern information.

However, the user behavior pattern information in each analysis period used to define the purchase time point behavior pattern information may a value changing according to time passage due to, for example, the amount of use of the washing machine changing according to the seasons, and user behavior pattern information corresponding to an analysis period closest to the current time point can be regarded to be closest to user's actual behavior pattern.

Therefore, an embodiment of the present disclosure applies a correction value to enable an average value in the number of times, by which the user has used the washing machine for the analysis periods, to be closer to user behavior pattern information corresponding to an analysis period closest to the current time point.

The correction value is determined by an average variance in the user behavior pattern information between adjacent analysis periods among the plurality of analysis periods (AP_1 to AP_10), that is, as an average value of differences, between adjacent analysis periods, in the number of times by which the washing machine has been used.

Further, in applying the correction value determined in the way as described above, when the average value in the number of times, by which the user has used the washing machine for the analysis periods, is larger than the number of times by which the washing machine has been used in the latest analysis period, the correction value may be subtracted from the average value in the number of times by which the user has used the washing machine for the analysis periods. In the opposite case, the correction value may be added to the average value in the number of times by which the user has used the washing machine for the analysis periods.

For example, in the example described above with reference to FIG. 7, when the average value in the number of times, by which the user has used the washing machine for the analysis periods (AP_1 to AP_10), corresponds to 97 times, the correction value corresponds to 3 times, and the number of times by which the washing machine has been used in the latest analysis period (AP_10) corresponds to 105 times, the correction value, 3, may be added to 97, the average value in the number of times, by which the user has used the washing machine for the analysis periods (AP_1 to AP_10), in order to make the purchase time point behavior pattern information become closer to the number of times by which the washing machine has been used in the latest analysis period (AP_10). As a result, the purchase time point behavior pattern information is defined as 100 times.

As another example, when the average value in the number of times, by which the user has used the washing machine for the analysis periods (AP_1 to AP_10), corresponds to 90 times, the correction value corresponds to 3 times, and the number of times by which the washing machine has been used in the latest analysis period corresponds to 81 times, the correction value, 3, may be subtracted from 90, the average value in the number of times, by which the user has used the washing machine for the analysis periods (AP_1 to AP_10), in order to make the purchase time point behavior pattern information become closer to the number of times by which the washing machine has been used in the latest analysis period. As a result, the purchase time point behavior pattern information is defined as 87 times.

Moreover, in steps S34 to S37, when it is determined that user's purchase time point behavior pattern information defined for each of products (consumable household products) matching the position (washing machine) wherein the sensing device 10 is located includes purchase time point behavior pattern information of a particular product (e.g., detergent), which coincides with the user behavior pattern information by a degree higher than or equal to a threshold value, the transfer unit 34 identifies the approaching of the exhaustion of the product and transfers, to the user device 20, notification information indicating that automatic purchase processing will be performed.

Specifically, when being notified, by the user device 20, of approaching of the washing machine at which the sensing device 10 is installed, the transfer unit 34 transfers, to the user device 20, notification information indicating that automatic purchasing will be progressed. Then, the user device 20 having received the notification information displays the notification information to enable the user to recognize the information and then agree with or deny the automatic purchasing in the service server 30.

The notification information displayed by the user device 20 may include a notification message “since an analysis result of past data shows that the detergent was exhausted when the washing machine had been used 110 times, the detergent which you have always used will be automatically purchased at the current time point when the washing machine has been used 100 times”, as described above with reference to FIG. 4.

Thereafter, in steps S38 and S39, when an intention to agree with automatic purchasing is received from the user device 20 after transferring the notification information to the user device 39 or a separate intention is not received for a predetermined standby time interval, the processing unit 35 proceeds with automatic processing of a product which is predicted to have approached its exhaust time point, to enable the product to be delivered even without user's intentional action.

As noted from the above description, elements of a service system according to an embodiment of the present disclosure enable, by applying a physical IoT device in the course of collecting personalized information, collection of information of even a part, collection of information of which is difficult by only software. Further, those elements can analyze the collected information to enable automatic product purchase even without user's action up to a time point before pre-transaction (pre-TR), and thus can provide a service environment in which a user (consumer) need not determine by himself or herself in relation to a product purchase behavior.

The implementations of the functional operations and subject matter described in the present disclosure may be realized by a digital electronic circuit, by the structure described in the present disclosure and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor unit, a computer, or all kinds of mechanisms, devices, and machines for data processing, including a multiprocessor unit and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

In a service server, an operation method thereof, and a user device according to the present disclosure, a re-purchase time point for a product is predicted based on user behavior pattern information identified from a sensing signal detected by an IoT-based sensing device to enable automatic re-purchasing of the product at the predicted time point. Therefore, the present disclosure provides a new service providing solution, which can overcome the conventional technical limit. Moreover, not only technologies related thereto can be used, but applied device thereof can also be sufficiently marketed or circulated. Therefore, the present disclosure can be obviously carried out and is thus industrially applicable.

What is claimed is:

1. A service server comprising:
a processor configured to perform a process to provide a service; and
a memory configured to store processor-readable instructions that, when executed by the processor, cause the processor to:
generate user behavior pattern information based on sensing information detected for a predetermined time interval by a sensing device;
determine whether purchase time point behavior pattern information defined for each product includes purchase time point behavior pattern information that corresponds to the user behavior pattern information within a predetermined threshold range; and
when purchase time point behavior pattern information of a particular product corresponds to the user behavior pattern information within the predetermined threshold range, transfer notification information indicating that automatic purchasing of the particular product is available.

2. The service server of claim 1, wherein the purchase time point behavior pattern information of the particular product is defined by user behavior pattern information based on an accumulation state of sensing information detected by the sensing device during an analysis period from a purchase time point of the particular product to a re-purchase time point of the particular product.

3. The service server of claim 2, wherein, when two or more analysis periods exist, the purchase time point behavior pattern information of the particular product is defined based on an average value of user behavior pattern information generated in the two or more analysis periods.

4. The service server of claim 3, wherein a correction value is applied to the average value of the user behavior pattern information such that the purchase time point behavior pattern information of the particular product is adjusted to be closer to user behavior pattern information when an analysis period becomes closer to a current time point.

5. The service server of claim 4, wherein the correction value is determined by an average variance in user behavior pattern information corresponding to adjacent analysis periods among the two or more analysis periods.

6. The service server of claim 1, wherein the memory configured to store the processor-readable instructions that, when executed by the processor, further cause the processor to:
acquire sensing information from a user device configured to receive the sensing information from the sensing device when entering a communication coverage of the sensing device.

7. The service server of claim 6, wherein the memory configured to store the processor-readable instructions that, when executed by the processor, cause the processor to:
transfer the notification information to the user device when it is identified that the user device enters the communication coverage of the sensing device.

8. A user device comprising:
a processor configured to perform a process associated with a service; and
a memory configured to store processor-readable instructions that, when executed by the processor, cause the processor to:
receive sensing information detected for a predetermined time interval by a sensing device;
transfer the sensing information received from the sensing device to a service server such that the service server generates user behavior pattern information based on the sensing information; and
display notification information indicating that automatic purchasing of the particular product is available, when purchase time point behavior pattern information defined for each product is determined to include purchase time point behavior pattern information of the particular product corresponding to the user behavior pattern information within a predetermined threshold range.

9. The user device of claim 8, wherein the sensing information and the notification information are received from the sensing device and the service server, respectively, when the user device enters the communication coverage of the sensing device.

10. An operation method of a service server, the operation method comprising:
generating user behavior pattern information based on sensing information detected for a predetermined time interval by a sensing device;
determining whether purchase time point behavior pattern information defined for each product includes purchase time point behavior pattern information that corresponds to the user behavior pattern information within a predetermined threshold range; and
when purchase time point behavior pattern information of a particular product corresponds to the user behavior pattern information within the predetermined threshold range, transferring notification information indicating that automatic purchasing of the particular product is available.

11. The operation method of claim 10, wherein the purchase time point behavior pattern information of the particular product is defined by user behavior pattern information based on an accumulation state of sensing information detected by the sensing device during an analysis period from a purchase time point of the particular product to a re-purchase time point of the particular product.

12. The operation method of claim 10, wherein, when two or more analysis periods exist, the purchase time point behavior pattern information of the particular product is defined based on an average value of user behavior pattern information generated in the two or more analysis periods.

13. The operation method of claim 12, wherein a correction value is applied to the average value of the user behavior pattern information such that the purchase time point behavior pattern information of the particular product is adjusted to be closer to user behavior pattern information when an analysis period becomes closer to a current time point.

14. The operation method of claim 11, wherein the correction value is determined by an average variance in user behavior pattern information corresponding to adjacent analysis periods among the two or more analysis periods.
